(19) United States
(12) Patent Application Publication
(10) Pub. No.: US 2014/0285743 A1
(43) Pub. Date: Sep. 25, 2014

(54) LIQUID CRYSTAL DISPLAY

(71) Applicant: HannStar Display Corp., New Taipei City (TW)

(72) Inventors: Chia-Hua Yu, New Taipei City (TW); Sung-Chun Lin, Tainan City (TW); Chien-Chuan Ko, Changhua County (TW); Hsien-Cheng Chang, Changhua County (TW); Hsuan-Chen Liu, Kaohsiung City (TW)

(73) Assignee: HannStar Display Corp., New Taipei City (TW)

(21) Appl. No.: 14/083,463

(22) Filed: Nov. 19, 2013

(30) Foreign Application Priority Data
Mar. 21, 2013 (CN) 201310093044.9

(51) Int. Cl. G02F 1/1343

(52) U.S. Cl. CPC G02F 1/134309
USPC 349/43

(57) ABSTRACT

A liquid crystal display includes a first substrate, a second substrate, and a liquid crystal layer, wherein the first substrate is disposed below the second substrate and the liquid crystal layer is disposed between the first substrate and the second substrates. The liquid crystal display further includes at least one thin film transistor, a common electrode, a first insulating layer, and at least one pixel electrode disposed on the upper surface of the first substrate in order. A plurality of bumps are disposed on the lower surface of the second substrate. The thin film transistor includes a gate, a source, and a drain.

### BACKGROUND OF THE INVENTION

1. Field of the Invention

The present invention is related to a liquid crystal display (LCD), and more particularly, to a liquid crystal display adopting HannStar ultra-high aperture (HUA) technology and with a plurality of bumps disposed on a side of the liquid crystal layer.

2. Description of the Prior Art

Liquid crystal displays have advantages of portability, low power consumption, and low radiation. Therefore, they are widely used in various portable information products, such as notebooks, personal data assistants (PDA), and have replaced cathode ray tube (CRT) monitor in desktop computers gradually.

Liquid crystal molecules serve as light valves in the liquid crystal display to control the light transmittance in each pixel of each scan time period. Based on the control mechanism of the liquid crystal molecules, liquid crystal displays can be divided into vertical alignment (VA) type liquid crystal displays and plane switching type liquid crystal displays.

Generally, VA type liquid crystal display has very short response time of liquid crystal molecules and is especially suitable for displaying dynamic information or images that have fast-moving object. As the related technology is continuously developed, the demand of displays with high definition grows rapidly. Besides WVGA (480×800) products, the products with standards of qHD (540×960) and HD (720×1280) and related technologies have been developed in succession. Moreover, in addition to high definition, liquid crystal display is required to have wide viewing angle when being applied to portable products. However, the researcher may meet the problem that the pixel opening ratio (also called “pixel aperture rate” or Pixel AR) will become lower when developing liquid crystal display with high PPI (Pixel per Inch) or with high pixel density. Therefore, it is still an important issue to design liquid crystal displays with both high pixel density and high pixel opening ratio.

### SUMMARY OF THE INVENTION

It is one of the main objectives of the present invention to disclose an liquid crystal display with HUA technology and a plurality of bumps for providing a display mode of multi-domain vertical alignment (MVA) with high pixel opening ratio, so as to solve the problem in the conventional liquid crystal display structure with low pixel opening ratio that is caused by the design of high pixel density.

According to an embodiment of the present invention, a liquid crystal display is disclosed. The present invention liquid crystal display includes a first substrate and a second substrate, wherein the first substrate is disposed below the second substrate. The present invention liquid crystal display further includes at least one thin film transistor (TFT) disposed on an upper surface of the first substrate, a common electrode disposed above the TFT, a first insulating layer disposed on the common electrode, a pixel electrode disposed on the first insulating layer, a liquid crystal layer disposed on the pixel electrode, and a plurality of bumps disposed on a lower surface of the second substrate, wherein the TFT includes a gate, a source, and a drain.

According to an embodiment of the present invention, a liquid crystal display is further disclosed. The present invention liquid crystal display includes a first substrate, a second substrate, and a liquid crystal layer, wherein the first substrate is disposed below the second substrate and the liquid crystal layer is disposed between the first substrate and the second substrate. The present invention liquid crystal display further includes a TFT disposed on an upper surface of the first substrate, a common electrode disposed above the TFT, a pixel electrode disposed on the common electrode, and a plurality of bumps disposed between the liquid crystal layer and the second substrate. The TFT includes a gate, a source and a drain and the pixel electrode includes at least one slit disposed between the projection shadows of two adjacent bumps.

It is an advantage of the present invention liquid crystal display that the common electrode is disposed below the pixel electrode such that the common electrode provides a shielding effect to prevent the pixel electrode from capacitor coupling effect caused by the data lines, scan lines and TFT(s). Therefore, the pixel electrode could have a greater size so that the pixel opening ratio can be raized. Furthermore, the design of bumps enables the liquid crystal molecules to arrange vertically, so as to improve the response time of liquid crystal molecules.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic top-view diagram according to a first embodiment of the present invention liquid crystal display.

FIG. 2 is a schematic sectional view of the liquid crystal display along the sectional line A-A shown in FIG. 1.

FIG. 3 is a schematic top-view diagram according to a second embodiment of the present invention liquid crystal display.

FIG. 4 is a schematic sectional view according to a third embodiment of the present invention liquid crystal display.

FIG. 5 is a schematic sectional view according to a fourth embodiment of the present invention liquid crystal display.

### DETAILED DESCRIPTION

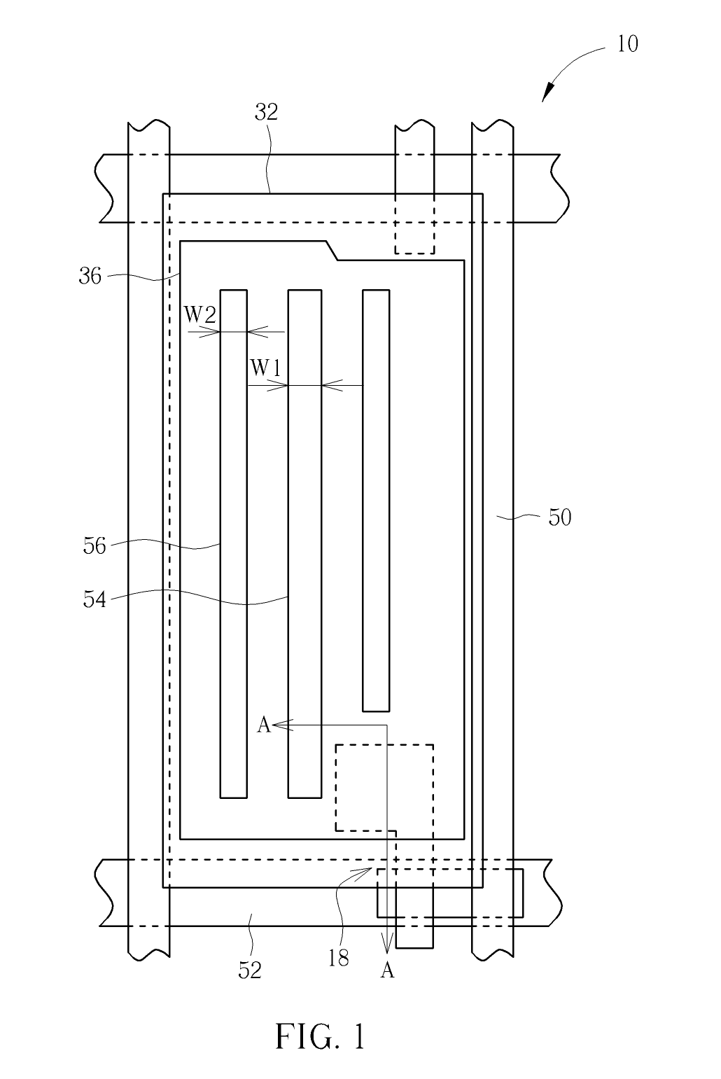

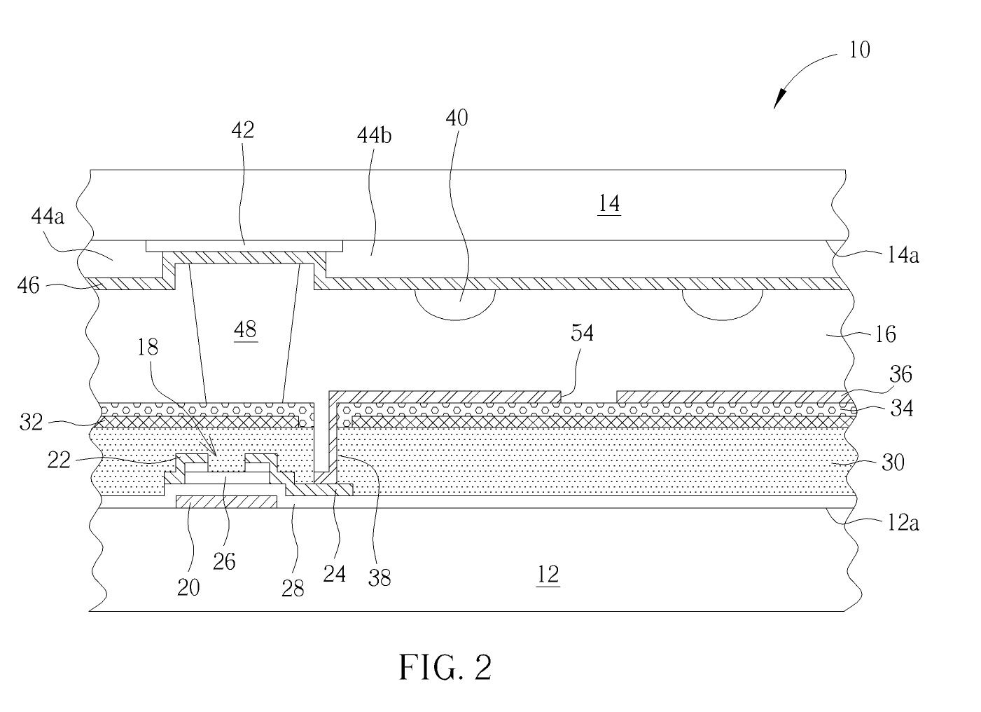

Referring to FIG. 1 and FIG. 2, FIG. 1 is a schematic top-view diagram according to a first embodiment of the present invention liquid crystal display and FIG. 2 is a schematic sectional view of the liquid crystal display along the sectional line A-A shown in FIG. 1. The present invention liquid crystal display 10 includes a first substrate 12, a second substrate 14 and a liquid crystal layer 16, wherein the first substrate 12 is disposed below the second substrate 14 and the liquid crystal layer 16 is disposed between the first substrate 12 and the second substrate 14. At least one TFT 18 is disposed on the upper surface 12a of the first substrate 12, including a gate 20, a source 22, a drain 24 and a semiconductor layer 26. In this embodiment, the present invention liquid crystal display 10 may include a plurality of TFTs 18, while FIG. 1 and FIG. 2 illustrate only one TFT 18 for explanation. Furthermore, a gate insulating layer 28 is disposed between the semiconductor layer 26 and the gate 20. The gates 20 may be formed by a first metal layer, and the sources 22 and the drains 24 may be formed by a second metal layer. The present invention liquid crystal display 10 further includes a first common electrode 32 disposed above the TFTs 18, a first insulating layer 34 disposed on the common electrode 32, and at least one pixel electrode 36 disposed on the first insulating layer 34. Therefore, the liquid crystal layer 16 is disposed above the pixel electrode 36. In a preferable embodiment, the liquid crystal display 10 further includes a second insulating layer 30 disposed between the TFTs 18 and the common electrode 32. In addition, the first insulating layer 34 and the second insulating layer 30 have at least one hole 38 that exposes the drain 24 such that the pixel electrode 36 can be electrically connected to the corresponding drain 24 through the hole 38. Furthermore, the liquid crystal display 10 includes a plurality of bumps 40 disposed on the lower surface 14a of the second substrate 14, which means the bumps 40 are disposed between the second substrate 14 and the liquid crystal layer 16. The bumps 40 preferably include material(s) with dielectric constant small than 0. In addition, the liquid crystal display 10 in FIG. 1 and FIG. 2 may include data lines 50 and scan lines 52 that are electrically connected to the source 22 and gate 20 respectively. In various embodiments, each source 22 may be a portion of its corresponding data line 50, and each gate 20 may be a portion of its corresponding scan line 52. Furthermore, the scan lines 52 and the gates 20 may be formed by the same first metal layer, and the data lines 50, the sources 22, and the drains 24 may be formed by the same second metal layer.

Moreover, the liquid crystal display 10 may optionally include a black matrix layer 42, a plurality of color filter layers 44a, 44b, and a transparent conductive layer 46 disposed on the lower surface 14a of the second substrate 14. One or more spacers 48 may be further disposed between the first substrate 12 and the second substrate 14. In this embodiment, the spacers 48 may be disposed right below the black matrix layer 42, in correspondence with the TFTs 18. Two adjacent color filter layers 44a, 44b are respectively formed by color filter material layers with different colors. Generally, color filter material layers may be composed of dyes of three primary colors, red, green, and blue respectively. Each pixel is composed of one red sub-pixel, one green sub-pixel, and one blue sub-pixel, such that the relative portion of the three primary color lights may contribute colorful images. In other embodiments, a pixel may include four sub-pixels of red, green, blue, and yellow for increasing the color saturation, and cyan and magenta sub-pixels may also be designed into the pixels for further increasing the color saturation because yellow, cyan, and magenta are the complementary colors of blue light, red light, and green light respectively. The transparent conductive layer 46 may be taking as another common electrode of the liquid crystal display 10. When displaying images, identical or different operation voltages may be respectively applied to the common electrode 32 and the transparent conductive layer 46. The materials of the common electrode 32, the pixel electrodes 36, and the transparent conductive layer 46 may include transparent conductive materials, such as tin indium oxide (ITO). The second insulating layer 30 and the first insulating layer 34 are formed with insulating materials and may include identical or different materials. In a preferable embodiment, the second insulating layer 30 and the first insulating layer 34 individually include a color translucent material layer or a transparent high-polymer material layer. The color translucent material layer and the transparent high-polymer material layer may include, for example, acrylic or silicon materials, wherein silicon nitride is an example of silicon material. The above-mentioned color translucent material layer may include one undyed or dyed photoresist materials or color filter material, and may be fabricated through coating, lithography, and development processes to form the required patterns, with a thickness of a range from about 1.0 micrometers to about 5.0 micrometers and a transmittance of about 10% to about 60%. The material of the above-mentioned transparent high-polymer material layer may be selected from at least one of poly(methyl methacrylate), also called PMMA, polycarbonate, and poly(ethylene terephthalate), also called PET. The thickness of the transparent high-polymer material layer may have a range from about 0.2 micrometers to about 3.0 micrometers, whose transmittance may be about 60% to about 90%. In a preferable embodiment, only one of the second insulating layer 30 and the first insulating layer 34 is needed to include transparent polymer material in order to provide planarization function to the whole surface of the upper side of the first substrate 12. In another embodiment, one of the second insulating layer 30 and the first insulating layer 34 may be formed with oxide material(s) or nitride material(s). However, the materials and relative material combination of the second insulating layer 30 and the first insulating layer 34 are not limited by the above description. In this embodiment, the second insulating layer 30 may serve as a protection layer, and the first insulating layer 34 may serve as a passivation layer. However, the functions of these two layers may be switched in various embodiments.

In another embodiment of the present invention, the structure of the liquid crystal display may not include the color filter layers 44a, 44b shown in FIG. 2, and the second insulating layer 30 disposed below the common electrode 32 may be formed by color translucent materials, which is the same as the materials of color filter layers. Therefore, the functionality of the second insulating layer 30 includes filtering three primary color lights. In that case, the second insulating layer 30 in each pixel or sub-pixel can individually filter out one color light among the three primary color lights and can also provide the insulation function at the same time, and therefore the total thickness of the liquid crystal display can be decreased since the color filter layers 44a, 44b shown in FIG. 2 is omitted. In a different embodiment, the first insulating layer 34 with color translucent materials may also be used to replace the color filter layers 44a, 44b in order to reach the objective for reducing the total thickness of the liquid crystal display. As mentioned above, when the second insulating layer 30 or the first insulating layer 34 with color translucent materials is used for replace the color filter layers 44a, 44b, its transmittance is preferably from about 10% to about 60% and its thickness is preferably from about 1.0 micrometers to about 5.0 micrometers.

In the liquid crystal display 10 shown in FIG. 1, the projection shadow of the common electrode 32 partially covers the data lines 50, the scan lines 52, and the TFTs 18, which means the area of the common electrode 32 can be enlarged outward, in contrast to the common electrode of conventional liquid crystal displays. Therefore, the common electrode 32 may provide shielding function such that the pixel electrode 36 will not be affected by the capacitor coupling effect from the data lines 50, scan lines 52, and TFTs 18, so as to avoid mura problem. In a different embodiment, the projection shadow of the common electrode 32 may only cover portions of the data lines 50 and the TFTs 18, but not cover the scan lines 52, in order to reduce the resistor-capacitor loading (RC loading) of the common electrode 32. In addition, since the pixel electrode 36 is disposed above the common electrode 32 and has a larger distance with the data lines 50 disposed below the pixel electrode 36, the electricity performance of the pixel electrode 36 is less affected by the data lines 50 such that the pixel electrode 36 can be designed to have a greater area. As shown in the top-view in FIG. 1, the projection shadow of the pixel electrode 36 is quite close to the data lines 50, and therefore the pixel opening ratio can be raised to reach the limit of the pixel area, especially in the cases of high-level display device with ultra-high definition and high PPI. Accordingly, the design of the structure of the present invention liquid crystal display 10 can effectively increase the pixel opening ratio. In addition, the common electrode 32 of the present invention liquid crystal display 10 is disposed below the pixel electrode 36, both of which are on the surface of the first substrate 12, thus the distance between the common electrode 32 and the pixel electrode 36 is quite smaller than that of a conventional liquid crystal display whose common electrode is disposed on the surface of the upper substrate. As a result, a capacitor with high storage content can be formed between the common electrode 32 and the pixel electrode 36, so as to reduce the kickback voltage.

The bumps 40 positioned at the lower side of the second substrate 14 may have shapes in geometric symmetry, such as sphere, diamond, or cone. In this embodiment, the bumps 40 have sphere shapes. By disposing the bumps 40, the arrangement of the liquid crystal molecules near the second substrate 14 can be adjusted to make the liquid crystal molecules arrange along the direction vertical or perpendicular to the surfaces of the bumps 40, so as to enable the liquid crystal display 10 to have VA function. In addition, the pixel electrode 36 may optionally have one or more slits 56 and even a main slit 54 on its surface, wherein each of the main slit 54 and the slits 56 is located between the projection shadows of two adjacent bumps 40. The width W1 of the main slit 54 is preferably greater than the width W2 of the slits 56. The relative positions of the slits 56 and the bumps 40 enables the arrangement of the liquid crystal molecules has the same function as a multi-domain alignment type display, and the main slit 54 can further control the liquid crystal molecules to align toward different directions or to divide the liquid crystal molecules in one pixel into several domains so as to provide compensation of viewing angles. It is noteworthy that the numbers and shapes of the main slit 54 and slits 56 shown in FIG. 1 is only an example for explanation, nor for limit the shapes and amounts of the slit and main slit of the pixel electrode 36 of the present invention. Furthermore, the shapes of the main slit 54 and slits 56 are not limited to strips or rectangular and may be any kind of shapes and is various. For example, the main slit 54 or the slits 56 may have “S” shape or “L” shape. In other embodiments, the pixel electrode 36 may have only one or several main slits 54, without any slit 56. In some other embodiments, the pixel electrode 36 may not have any slit or main slit.

The liquid crystal display of the present invention is not limited by the aforementioned embodiment, and may have other different preferred embodiments and variant embodiments. To simplify the description, the identical components in each of the following embodiments are marked with identical symbols. For making it easier to compare the difference between the embodiments, the following description will detail the dissimilarities among different embodiments and the identical features will not be redundantly described.

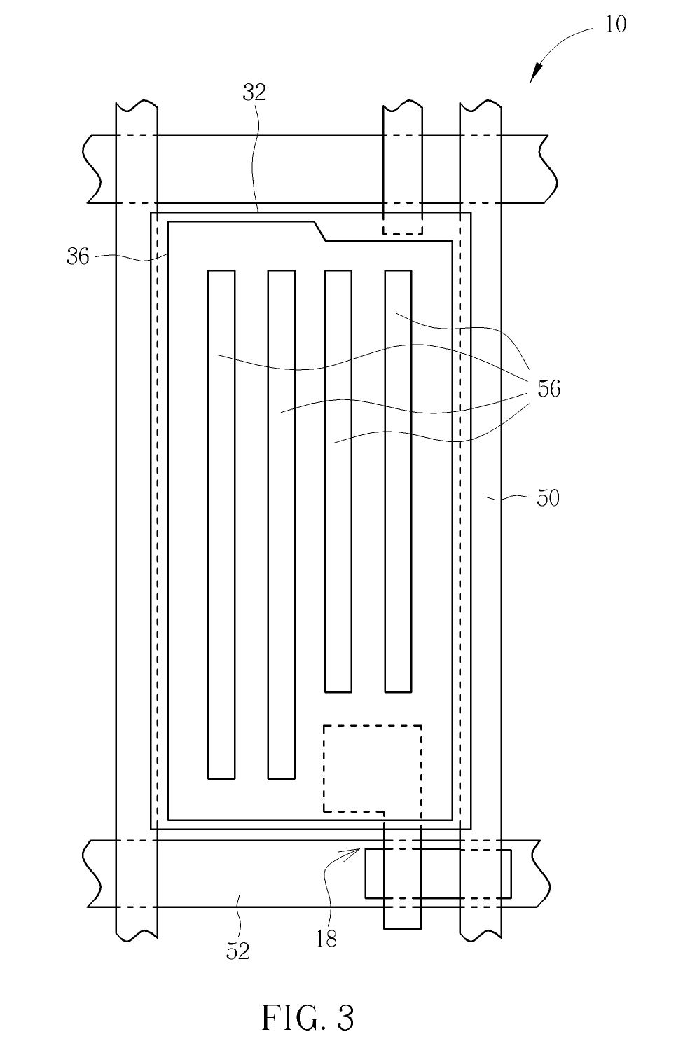

Referring to FIG. 3, FIG. 3 is a schematic top-view diagram according to a second embodiment of the present invention liquid crystal display. As shown in FIG. 3, the difference of this embodiment and the first embodiment is that the common electrode 32 of this embodiment covers portions of the data lines 50 and the corresponding TFT 18 but does not cover the scan lines 52. In this design, the RC loading of the common electrode 32 can be reduced. In addition, the pixel electrode 36 of this embodiment includes four slits 56 with the same widths, but not limited thereto.

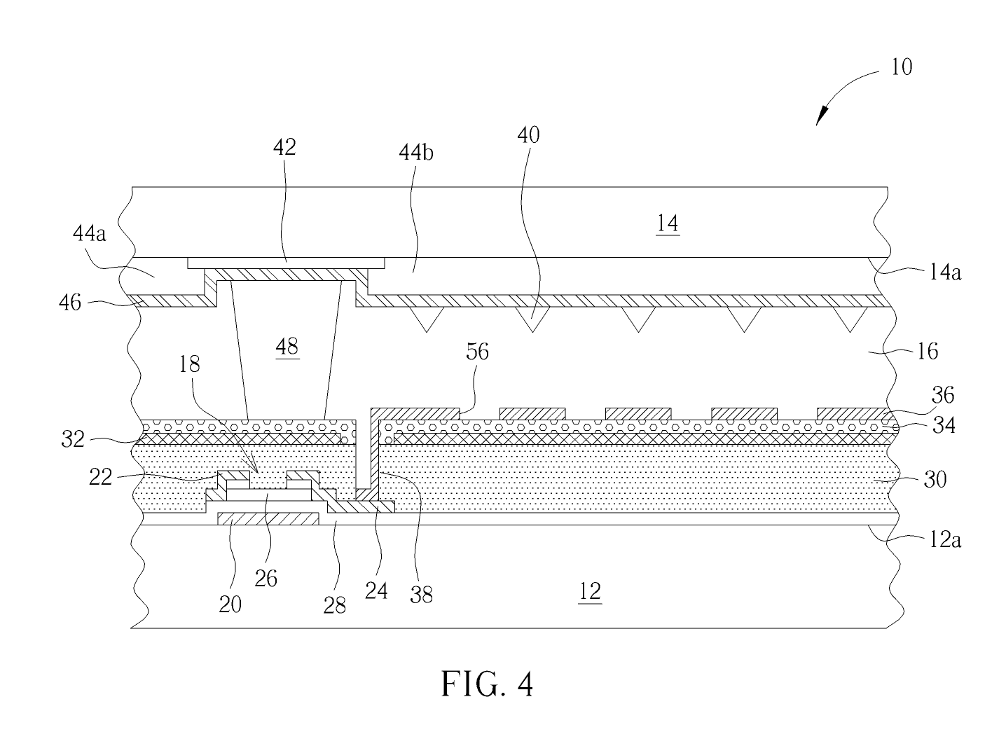

Referring to FIG. 4, FIG. 4 is a schematic sectional view according to a third embodiment of the present invention liquid crystal display. As shown in FIG. 4, in this embodiment, the bumps 40 have cone shapes, whose numbers is greater than those in the first embodiment, but with smaller size. In addition, the pixel electrode 36 includes a plurality of slits 56 disposed between the projection shadows of two adjacent bumps 40 respectively. In a preferable embodiment, each slit 56 is corresponding to the center of the spacing between the projection shadows of two bumps 40 adjacent to each other. By disposing the bumps 40 and slits 56, the liquid crystal display 10 has the function of MVA or VA, such that the viewing angle is increased and the response time of the liquid crystal molecules is reduced.

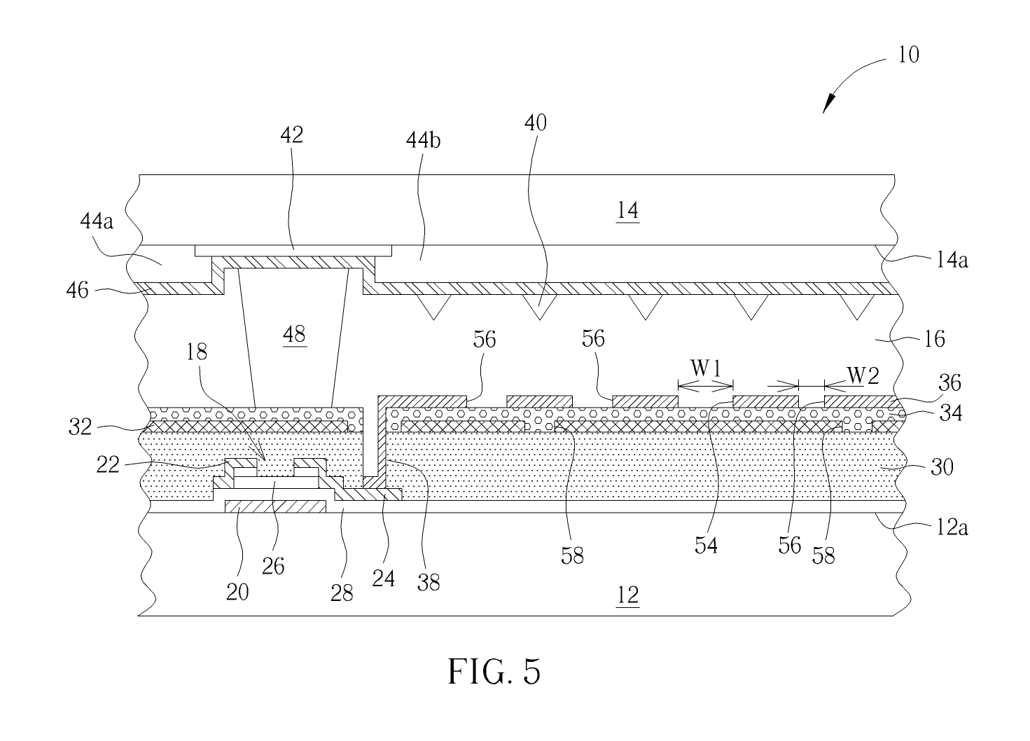

Referring to FIG. 5, FIG. 5 is a schematic sectional view according to a fourth embodiment of the present invention liquid crystal display. In contrast to the previous embodiment, the pixel electrode 36 in this embodiment includes a plurality of slits 56 and at least one main slit 54, wherein the width W1 of the main slit 54 is greater than the width W2 of slits 56. Furthermore, the common electrode 32 includes at least one opening 58 corresponding to the portion of the pixel electrode 36 without the slits 56 and the main slit(s) 54, for instance. By disposing the openings 58, the area of the common electrode 32 is reduced while the conductive property of the common electrode 32 is not affected, thus the storage capacitor content formed between the common electrode 32 and the pixel electrode 36 is reduced. As a result, the storage capacitor content can be adjusted by the way of disposing the openings 58 in the common electrode 32 and designing the pattern and size of the openings 58 so as to avoid insufficient charge of capacitor resulted from a too big storage capacitor. According to the present invention, adjusting the storage capacitor by disposing the opening(s) 58 in the common electrode 32 further includes the advantage that it is much flexible for the designer to adjust the storage capacitor because the opening ratio will not be affected when the shape of the common electrode 32 is changed.

In order to illustrate the effect of the present invention technology with high pixel opening ratio in contrast to the conventional technology, a comparison of the experimental data of the pixel opening ratios of the best-mode conventional VA technology and the present invention HUA technology is shown in Table 1.

TABLE 1
Comparison of the pixel opening ratios of the conventional
VA technology and the present invention HUA technology

| | | | | (E) |
|---|---|---|---|---|
| | | (C) | (D) | Increasing |
| | | Opening ratio | Opening | rate of |
| | | of the | ratio of | opening |
| | | best-mode | the | ratio of the |
| (A) | (B) | conventional | present | present |
| Display type | PPI | VA display | invention | invention |
| 4.3″ WVGA | 217 | 43.10% | 55.29% | 28.28% |
| (39 × 117) | | | | |
| 4.3″qHD | 256 | 34.74% | 51.59% | 48.50% |
| (33 × 99) | | | | |
| 5.3″ HD | 285 | 25.99% | 46.50% | 78.91% |
| (29.75 × 89.25) | | | | |
| 5″ HD | 300 | 23.40% | 42.78% | 82.82% |
| (28.25 × 84.75) | | | | |
| 4.7″ HD | 323 | 19.75% | 38.56% | 95.24% |
| (26.25 × 78.75) | | | | |
| 4.3″ HD | 342 | 17.18% | 35.24% | 105.12% |
| (24.75 × 74.25) | | | | |

As shown in Table 1, the content numbers of the “(B) PPI” column are increased from top with “217” to bottom with “342”; it means the lower object has higher definition. In the best-mode conventional VA technology, the opening ratio is gradually reduced from 43.10% (in the upmost row) to 17.18% (in the lowest row) . In another aspect, the opening ratio of the present invention is gradually reduced from the upmost 55.3% to the lowest 35.24%. Among all the illustrated liquid crystal display with any definition levels or types, the opening ratios of the present invention are greater than those of the best-mode conventional VA liquid crystal display, and the least difference is 11%. The calculation equation of the “(E) Increasing rate of opening ratio of the present invention” in the most right column is: ((D)-(C))/(C). Therefore, one can understand from Table 1 that the present invention technology can effectively increase the pixel opening ratio, especially in display panel with high PPI or high definition, and the increasing rate can up to 105%. As a result, the present invention technology can raise the total light luminance from of the displayed image, and therefore a backlight source with lower luminance can be adopted such that the standby time for the cell of a portable device with the present invention liquid crystal display can be longer. Furthermore, since the pixel opening ratio is raised, the tiny black spacing between adjacent pixels becomes smaller such that the displayed image becomes more delicate.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A liquid crystal display (LCD), comprising:
a first substrate and a second substrate, wherein the first substrate is disposed below the second substrate;
at least one thin film transistor (TFT) disposed on an upper surface of the first substrate, the TFT including a gate, a source and a drain;
a common electrode disposed above the TFT;
a first insulating layer disposed on the common electrode;
a pixel electrode disposed on the first insulating layer;
a liquid crystal layer, disposed on the pixel electrode; and
a plurality of bumps, disposed on a lower surface of the second substrate.

2. The liquid crystal display of claim 1, further comprising a second insulating layer disposed between the common electrode and the TFT.

3. The liquid crystal display of claim 2, wherein each of the first insulating layer and the second insulating layer comprises at least one of a color translucent material layer and a transparent high-polymer material layer, and the first insulating layer and the second insulating layer have identical materials or different materials.

4. The liquid crystal display of claim 3, wherein the color translucent material layer or the transparent high-polymer material layer comprises acrylic or silicon.

5. The liquid crystal display of claim 1, wherein the bumps have shapes in geometric symmetry and comprise a shape of sphere, diamond, or cone.

6. The liquid crystal display of claim 1, further comprising:
at least one data line, disposed on the upper surface of the first substrate and electrically connected to the source; and
at least one scan line disposed on the upper surface of the first substrate and electrically connected to the gate;
wherein a projection shadow of the common electrode partially covers the data line and the TFT.

7. The liquid crystal display of claim 1, wherein the pixel electrode has at least one slit disposed between projection shadows of two of the bumps adjacent to each other.

8. The liquid crystal display of claim 1, wherein the pixel electrode has at least one main slit and at least one slit disposed between projection shadows of two of the bumps adjacent to each other respectively, and a width of the main slit is greater than a width of the slit.

9. The liquid crystal display of claim 1, wherein the common electrode has at least one opening.

10. A liquid crystal display, comprising:
a first substrate and a second substrate, wherein the first substrate is disposed below the second substrate;
a liquid crystal layer disposed between the first substrate and the second substrate;
at least one TFT disposed on an upper surface of the first substrate, the TFT including a gate, a source, and a drain;
a common electrode disposed above the TFT;
a pixel electrode disposed above the common electrode; and
a plurality of bumps disposed between the liquid crystal layer and the second substrate;
wherein the pixel electrode comprises at least one slit disposed between projection shadows of two of the bumps adjacent to each other.
